(19) United States
(12) Patent Application Publication
(10) Pub. No.: US 2018/0242614 A1
(43) Pub. Date: Aug. 30, 2018

(54) PSYLLIUM PET FOOD COMPOSITION

(71) Applicant: Sugar Creek Pet Products LLC, Meta, MO (US)

(72) Inventor: Mark Brinkmann, Jefferson City, MO (US)

(21) Appl. No.: 15/880,175

(22) Filed: Jan. 25, 2018

Related U.S. Application Data
(60) Provisional application No. 62/464,940, filed on Feb. 28, 2017.

(51) Int. Cl. A23K 20/163; A23K 20/147; A23K 20/174; A23K 50/40

(52) U.S. Cl. CPC A23K 20/163; A23K 50/40; A23K 20/174; A23K 20/147

(57) ABSTRACT

A pet food is comprised of about 49.7% starch source, about 36.5% protein source, about 5.3% fiber, about 1.7% vitamins and minerals; and wherein about 4% of the fiber (or about 0.2 wt % of the pet food) is psyllium husk.

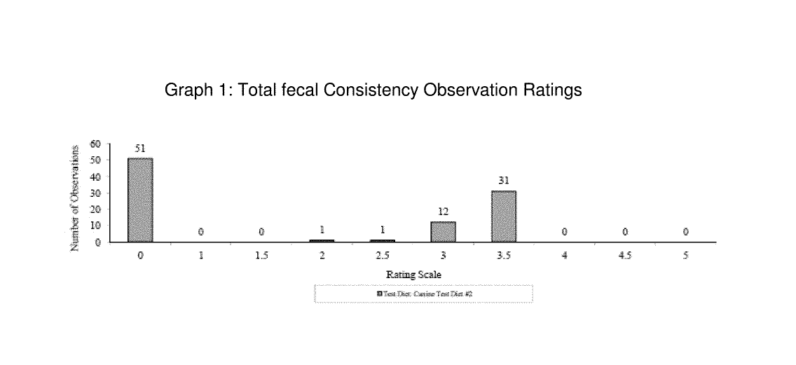

### CROSS-REFERENCE TO RELATED APPLICATIONS

This application claims priority to U.S. App. No. 62/464,940 filed Feb. 28, 2017, entitled Psyllium Pet Food Composition, and which is incorporated herein by reference.

### STATEMENT REGARDING FEDERALLY SPONSORED RESEARCH OR DEVELOPMENT

Not Applicable.

### BACKGROUND

This application relates to pet foods, and in particular to a pet food for dogs or cats which includes psyllium husks as a source of fiber.

Psyllium husks are derived from the seed of the Plantago psyllium L plant. Mucilage produced from psyllium husks can absorb up to 10 times its weight in water, and has been used to normalize bowel movements in pets as well as in humans. Psyllium's ability to bind fecal matter, and thus increase stool size, has also been found to be beneficial for treating anal gland disease.

Studies have shown that psyllium may lower cholesterol and LDL's. There have also been indications that psyllium can decrease glucose absorption in humans with type-2 diabetes. However, psyllium is also known to detrimentally affect the absorption of vitamins, minerals, and some medications. In addition, psyllium can alter the action of some medications. In view of these contraindications, psyllium has not been promoted for continuous (i.e., daily) use.

However, we have found that psyllium can be included in pet food in small amounts (i.e., below 0.3 wt % of the pet food, and preferably in the range of about 0.15% to about 0.25% by weight). At these levels, the beneficial effects of the psyllium are still evident, and the potential for the noted side effects are substantially reduced.

### SUMMARY

Briefly stated, a pet food mixture is comprised of about 45 wt % to about 55 wt % of a starch, about 30 wt % to about 40 wt % protein, about 1 wt % to about 3 wt % mineral ingredients, and about 2 wt % to about 7 wt % fiber, wherein up to about 12% of the fiber is psyllium husk.

In accordance with an aspect of the pet food, the pet food is about 0.15 wt % to about 0.25 wt % psyllium husk.

In accordance with an aspect of the pet food, the pet food is comprised of about 49.7% starch source, about 36.5% protein source, about 5.3% fiber, about 1.7% vitamins and minerals; and wherein about 4% of the fiber (or about 0.2 wt % of the pet food) is psyllium husk.

The pet food can also include a preservative and probiotics.

In an illustrative embodiment, the pet food can further comprise about 5% fat sources, about 1.7% vitamins and minerals, about 0.1% probiotics and prebiotics, about 1.5% flavoring.

### DESCRIPTION OF THE FIGURES

The FIGURE is a graph of fecal consistency observation ratings found in Table 10 with the frequency distribution.

### DETAILED DESCRIPTION

The following detailed description illustrates the claimed invention by way of example and not by way of limitation. This description will clearly enable one skilled in the art to make and use the claimed invention, and describes several embodiments, adaptations, variations, alternatives and uses of the claimed invention, including what I presently believe is the best mode of carrying out the claimed invention. Additionally, it is to be understood that the claimed invention is not limited in its application to the details of construction and the arrangements of components set forth in the following description or illustrated in the drawings. The claimed invention is capable of other embodiments and of being practiced or being carried out in various ways. Also, it is to be understood that the phraseology and terminology used herein is for the purpose of description and should not be regarded as limiting.

In our tests, we found that pet food mixture comprised generally of about 45 wt % to about 55 wt % of starch sources, about 30 wt % to about 40 wt % protein sources, about 1 wt % to about 3 wt % mineral ingredients, and about 2 wt % to about 7 wt % fiber, wherein up to about 12% of the fiber is psyllium husk (such that the pet food has about 0.15 wt % to about 0.25 wt % psyllium) is easily digestible for the dog, and is easy on the dog's stomach.

In a preferred embodiment, the pet food is comprised of about 49.7% starch source, about 36.5% protein source, about 5.3% fiber, about 5% fat sources; about 1.7% vitamins and minerals; about 0.1% probiotics and prebiotics; and about 1.5% flavoring. The pet food also preferably includes a preservative and probiotics. About 4% of the fiber (or about 0.2 wt % of the pet food) is psyllium A first formulation for the pet food is shown in Table 1.

TABLE 1

| Ingredient | Wt % | Ingredient Purpose |
|---|---|---|
| White Potatoes | 49.727 | Starch source |
| Egg Product | 29.000 | Protein source |
| Potato Protein | 7.500 | Protein source |
| Tomato Pomace | 5.000 | Soluble fiber |
| Chicken Fat | 2.000 | Fat source |
| Flaxseed | 2.000 | Omega 3 Source |
| Natural Dog Flavor | 1.500 | Flavoring |
| Menhaden Oil | 1.000 | Omega fatty acid |
| Dical Phosphate | 1.000 | Calcium and |
| | | Phosphorus Source |
| Psyllium Husks | 0.200 | Fiber |
| Ginger | 0.200 | Stomach soother |
| Mineral Mix Dog | 0.200 | Mineral source |
| Calcium Carbonate | 0.200 | Calcium source |
| Vitamin Pmx Dog | 0.200 | Vitamin source |
| Dried Chicory Root | 0.100 | Prebiotic Fiber |
| Choline Chloride | 0.100 | Vitamin Source |
| Natural Antioxidant | 0.070 | Preservative |
| Probiotics Blend | 0.003 | Probiotics for gut health |

This formulation results in the nutritional composition shown below in Table 2:

TABLE 2

| Nutritional | As | Dry | | Reporting |
|---|---|---|---|---|
| Component | Received | Weight | Units | limit |
| Moisture | 5.52 | /////// | % | 0.01 |
| Dry matter | 94.48 | /////// | % | 0.01 |
| Protein (crude) | 25.9 | 27.4 | % | 0.20 |
| Fat (acid hydrolysis) | 15.1 | 16.0 | % | 0.10 |
| Fiber (crude) | 3.59 | 3.80 | % | 0.20 |
| Ash | 6.22 | 6.58 | % | 0.10 |
| Sulfur (total) | 0.50 | 0.53 | % | 0.01 |
| Phosphorus (total) | 0.85 | 0.90 | % | 0.01 |
| Potassium (total) | 0.96 | 1.02 | % | 0.01 |
| Magnesium (total) | 0.11 | 0.12 | % | 0.01 |
| Calcium (total) | 1.35 | 1.43 | % | 0.01 |
| Sodium (total) | 0.39 | 0.41 | % | 0.01 |
| Iron (total) | 458 | 485 | ppm | 5.0 |
| Manganese (total) | 29.6 | 31.3 | ppm | 1.0 |
| Copper (total) | 13.5 | 14.3 | ppm | 1.0 |
| Zinc (total) | 200 | 212 | ppm | 1.0 |
| Starch (gelatinized) | 31.34 | 33.17 | % | 0.10 |
| Starch (total) | 33.51 | 35.47 | % | 0.10 |
| Percent gelatinized | 93.52 | | % | 0.00 |

The formulation of Table 1 was fed to six dogs (four male and two female) each of which was at least one year of age, for 10 days. The test diet was the sole source of food for the 10-day period. During the 10-day testing period, the dogs were housed individually and presented with the test diet on an individual basis (i.e., each dog had its own food bowl). Cages and bowls were cleaned daily and sanitized in accordance with the Animal Welfare Act. The dogs were fed once daily at the same time each day. Body weights were recorded on Days 1 through 6, and on Day 10. The first five (5) days of the 10-day test period were considered an acclimation period for the dogs to become acclimated to the pet food. Food consumption was recorded daily. On days 6 through 11, fecal matter/stool was collected and analyzed. Stool quality observations were measured and recorded according to a photo grading sheet a minimum of three times daily during the collection period. A summary of body weights, food consumption, and grams of fecal output can be found in Tables 3 through 5 respectively. Fecal consistency observation ratings can be found in Table 10 with the frequency distribution in Graph 1. After the final fecal collection, each of six (6) individual fecal samples was sent to Eurofins US, a laboratory services firm located Des Moines, Iowa, for analytical determination as appears in Table 6. A sample of test diet of Table 1 was also analyzed and the results of the analyses can be found in Table 6.

The results of the analyses on the feces and the test diet were used to calculate dry matter, protein, caloric digestibility and metabolizable energy as presented in Table 7. Actual equations for the calculations are presented in Table 11. Comparison of metabolizable energy between proximate analysis method and digestibility trial method can be found in Tables 8 and 9.

TABLE 3
Body weights (kg)

| Dog | | | | | | | | Day | | % |
|---|---|---|---|---|---|---|---|---|---|---|
| ID | Sex | Day 1 | Day 2 | Day 3 | Day 4 | Day 5 | Day 6 | 10 | Change | Change |
| 1 | M | 11.87 | 11.73 | 11.69 | 1.55 | 11.54 | 11.46 | 11.50 | −0.37 | −3.12% |
| 2 | M | 10.12 | 10.11 | 10.02 | 10.20 | 9.99 | 9.93 | 10.05 | −0.07 | −0.69% |
| 3 | F | 9.53 | 9.37 | 9.40 | 9.40 | 9.33 | 9.20 | 9.25 | −0.28 | −2.94% |
| 4 | M | 12.75 | 12.73 | 12.54 | 12.51 | 12.38 | 12.36 | 12.33 | −0.42 | −3.29% |
| 5 | F | 8.31 | 8.36 | 8.53 | 8.51 | 8.36 | 8.04 | 8.29 | −0.02 | −0.24% |
| 6 | M | 10.81 | 10.73 | 10.73 | 10.73 | 10.83 | 10.71 | 10.76 | −0.05 | −0.46% |
| | | | | | | | | Mean | −0.20 | −1.79% |
| | | | | | | | | SEM | 0.072 | 0.598% |

TABLE 4
Daily Food Consumption (g)

| Dog | | | | | | | | | | Day | Day 6-10 |
|---|---|---|---|---|---|---|---|---|---|---|---|
| ID | Day 1 | Day 2 | Day 3 | Day 4 | Day 5 | Day 6 | Day 7 | Day 8 | Day 9 | 10 | Total |
| 1 | 300 | 207 | 310 | 157 | 320 | 330 | 330 | 254 | 194 | 202 | 1310 |
| 2 | 260 | 203 | 190 | 163 | 111 | 141 | 189 | 186 | 261 | 214 | 991 |
| 3 | 167 | 168 | 148 | 129 | 107 | 116 | 128 | 213 | 156 | 250 | 863 |
| 4 | 219 | 281 | 300 | 310 | 189 | 320 | 320 | 320 | 320 | 320 | 1600 |
| 5 | 217 | 192 | 255 | 132 | 108 | 130 | 268 | 300 | 238 | 300 | 1236 |
| 6 | 173 | 216 | 222 | 300 | 199 | 300 | 300 | 300 | 300 | 300 | 1500 |
| | | | | | | | | | | Mean | 1250 |
| | | | | | | | | | | SEM | 1163 |

TABLE 5
Fecal Weights (g)

| Dog ID | Day 6 | Day 7 | Day 8 | Day 9 | Day 10 | Total |
|---|---|---|---|---|---|---|
| 1 | 7 | 120 | 143 | 101 | 153 | 524 |
| 2 | 10 | 0 | 80 | 35 | 96 | 221 |
| 3 | 13 | 52 | 153 | 53 | 157 | 428 |
| 4 | 11 | 156 | 117 | 157 | 268 | 709 |
| 5 | 17 | 105 | 148 | 188 | 202 | 660 |
| 6 | 20 | 120 | 193 | 160 | 195 | 688 |

TABLE 6
Diet & Fecal Analysis

| | Test | Fecal Analysis by Dog ID | | | | | |
|---|---|---|---|---|---|---|---|
| | Diet | 1 | 2 | 3 | 4 | 5 | 6 |
| Moisture % | 4.50 | 72.85 | 68.70 | 72.48 | 76.33 | 73.01 | 73.10 |
| Fat % | 15.44 | 1.51 | 1.92 | 1.55 | 1.35 | 1.43 | 1.36 |
| Protein % | 24.28 | 6.04 | 7.80 | 6.23 | 5.38 | 6.86 | 6.42 |
| Fiber % | 2.6 | 4.0 | 4.7 | 4.2 | 3.6 | 4.5 | 3.8 |
| Ash % | 5.97 | 5.64 | 6.18 | 5.97 | 4.35 | 5.98 | 5.48 |
| Phosphorus % | 0.70 | | | | | | |
| Calcium % | 1.09 | | | | | | |
| Cal/phos | 1.56 | | | | | | |
| Calorie (kcal/g) | 4.88 | 1.04 | 1.25 | 1.12 | 0.99 | 1.10 | 1.09 |
| (from calculation) | | | | | | | |
| Calorie (kcal/g) | 4.88 | 1.04 | 1.25 | 1.12 | 0.99 | 1.10 | 1.09 |
| (bomb calorimetry) | | | | | | | |

TABLE 7
Fecal Matter Calculations

| | Dog ID | | | | | | | |
|---|---|---|---|---|---|---|---|---|
| | 1 | 2 | 3 | 4 | 5 | 6 | Mean | SEM |
| Dry matter (total) digestibility (%) | 88.6 | 92.7 | 85.7 | 89.0 | 84.9 | 87.1 | 88.0 | ±1.14 |
| Protein digestibility (%) | 90.0 | 92.8 | 87.3 | 90.2 | 84.9 | 87.9 | 88.9 | ±1.13 |
| Fat digestibility (%) | 96.1 | 97.2 | 95.0 | 96.1 | 95.1 | 96.0 | 95.9 | ±0.33 |
| Caloric digestibility (%) | 91.5 | 94.3 | 88.6 | 91.0 | 88.0 | 89.8 | 90.5 | ±0.93 |
| Metabolizable Energy (kcal/g) | 4.19 | 4.32 | 4.06 | 4.17 | 4.03 | 4.11 | 4.15 | ±0.042 |
| Caloric digestibility (%) | 91.5 | 94.3 | 88.6 | 91.0 | 88.0 | 89.8 | 90.5 | ±0.93 |
| Metabolizable Energy (kcal/g) | 4.19 | 4.32 | 4.06 | 4.17 | 4.03 | 4.11 | 4.15 | ±0.042 |

TABLE 8
Digestibility Trial Method

| | Gross | | Gross | | | | | |
|---|---|---|---|---|---|---|---|---|
| | Energy | Food | Energy | Fecal | Protein | Protein | Correction | |
| Dog | Food AF | Intake | Feces | Output | Food | Feces | Factor | ME |
| ID | (kcal/g) | AF (g) | (kcal/g) | (g) | AF (%) | (%) | Dog | (kcal/kg) |
| 1 | 4.88 | 1310 | 1.04 | 524 | 24.28 | 6.04 | 1.25 | 4191 |
| 2 | 4.88 | 991 | 1.25 | 221 | 24.28 | 7.80 | 1.25 | 4319 |
| 3 | 4.88 | 863 | 1.12 | 428 | 24.28 | 6.23 | 1.25 | 4060 |
| 4 | 4.88 | 1600 | 0.99 | 709 | 24.28 | 5.38 | 1.25 | 4168 |
| 5 | 4.88 | 1236 | 1.10 | 660 | 24.28 | 6.86 | 1.25 | 4035 |
| 6 | 4.88 | 1500 | 1.09 | 688 | 24.28 | 6.42 | 1.25 | 4113 |

TABLE 9
Pet Food Analysis

| Crude | Crude | Crude | | | | | |
|---|---|---|---|---|---|---|---|
| Protein | Fat | Fiber | Moisture | Ash | NFE | Gross | |
| (%) | (%) | (%) | (%) | (%) | (%) | Energy | ME |
| AF | AF | AF | AF | AF | AF | (kcal/g) | (kcal/g) |
| 24.28 | 15.44 | 2.6 | 4.50 | 5.97 | 47.21 | 4.78 | 3815 |

TABLE 10
Total Fecal Consistency Observation Ratings

| Dog | | Day 6 | | Day 7 | | | Day 8 | | | Day 9 | | | Day 10 | | | Day 11 |
|---|---|---|---|---|---|---|---|---|---|---|---|---|---|---|---|---|
| ID | Sex | PM | AM | Midday | PM | AM | Midday | PM | AM | Midday | PM | AM | Midday | PM | AM | Midday |
| 1 | M | 0 | 3.5 | 0 | 0 | 3.5 | 0 | 0 | 3.5 | 3.5 | 0 | 3.5 | 0 | 0 | 3.5 | 3 |
| 2 | M | 0 | 3 | 0 | 0 | 0 | 0 | 0 | 3 | 3.5 | 0 | 3.5 | 0 | 0 | 3.5 | 3.5 |
| 3 | F | 0 | 3.5 | 0 | 0 | 3.5 | 0 | 0 | 3.5 | 0 | 0 | 3.5 | 0 | 0 | 3.5 | 3.5 |
| 4 | M | 0 | 3.5 | 0 | 0 | 3, 3.5 | 0 | 0 | 3.5 | 0 | 0 | 3, 3.5 | 0 | 0 | 3.5 | 3 |
| 5 | F | 0 | 3.5 | 0 | 0 | 3.5 | 0 | 0 | 3.5 | 0 | 0 | 3.5 | 3 | 0 | 3, 3.5 | 3, 3.5 |
| 6 | M | 0 | 3 | 0 | 0 | *3, 3.5 | 2.5 | 0 | 3.5 | 3 | 0 | 3.5 | 0 | 0 | 2, 3.5 | 0 |

*food vomit

The rating scale for the fecal matter observations are as follows:

| RATING SCALE: | Number of observations |
|---|---|
| 0 = none | 51 |
| 1 = watery diarrhea | 0 |
| 1.5 = diarrhea | 0 |
| 2 = moist, no form | 1 4. |
| 2.5 = moist, some form | 1 |
| 3 = moist, formed | 12 |
| 3.5 = well formed, sticky | 31 |
| 4 = well formed | 0 |
| 5 = hard, dry | 0 |
| 5 = hard, dry, crumbly | 0 |

TABLE 9
Calculations

Dry Matter (Total) Digestibility = [{(Total Food Consumed) × (% Dry
Matter of Food)} − {(Total Weight of Stool) × (% Dry Matter of
Stool)}] ÷ {(Total Food Consumed) × (% Dry Matter of Food)}
Protein Digestibility = [{(Total Food Consumed) × (% Protein of
Food)} − {(Total Weight of Stool) × (% Protein of Stool)}] ÷ {(Total
Food Consumed) × (% Protein of Food)}
Fat Digestibility = [{(Total Food Consumed) × (% Fat of Food)} −
{(Total Weight of Stool) × (% Fat of Stool)}] ÷ {(Total Food
Consumed) × (% Fat of Food)}
Caloric Digestibility = [{(Total Food Consumed) × (Gross Energy
per gram of diet)} − {(Total Weight of Stool) × (Gross Energy
per gram of Stool)}] ÷ {(Total Food Consumed) × (Gross Energy
per gram of diet)}
Metabolizable Energy (M.E.) = {Gross Energy of Diet − Gross Energy
of Stool − (Grams Protein Digested × 1.25 kcal/g)} ÷ Amount of Food
Consumed
Calculated Gross Energy = ((9.4 × Fecal Fat) + (5.65 × Fecal Protein) +
(4.15 × Fecal NFE))/10
Nitrogen-free Extract (NFE) = 100 − (% Crude Protein + % Crude Fat +
% Crude Fiber + % Moisture + % Ash)
Modified Atwater M.E. (kcal/kg) = 10 × {(3.5 × Crude Protein) + (8.5 ×
Crude Fat) + (3.5 × NFE)}
Gross Energy (kcal/g) = {(5.65 × Crude Protein) + (4.15 × NFE) + (9.4 ×
Crude Fat)} ÷ 100

As various changes could be made in the above compositions without departing from the scope of the invention, it is intended that all matter contained in the above description or shown in the accompanying drawings shall be interpreted as illustrative and not in a limiting sense.

1. A pet food mixture comprised of:
about 45 wt % to about 55 wt % of a starch,
about 30 wt % to about 40 wt % protein,
about 1 wt % to about 3 wt % mineral ingredients, and
about 2 wt % to about 7 wt % fiber, wherein up to about 12% of the fiber is psyllium husk.

2. The pet food of claim 1 wherein the pet food is about 0.15 wt % to about 0.25 wt % psyllium husk.

3. The pet food of claim 1 wherein the pet food is comprised of about 49.7% starch source, about 36.5% protein source, about 5.3% fiber, about 1.7% vitamins and minerals; and wherein about 4% of the fiber (or about 0.2 wt % of the pet food) is psyllium husk.

4. The pet food of claim 3 wherein the pet food is further comprised of about 5% fat sources; about 1.7% vitamins and minerals; about 0.1% probiotics and prebiotics; about 1.5% flavoring.

5. The pet food of claim 3 wherein the pet food further includes a preservative and probiotics.
